(19) United States
(12) Patent Application Publication
(10) Pub. No.: US 2022/0005629 A1
(43) Pub. Date: Jan. 6, 2022

(54) INSULATED WIRE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Toyoki FURUKAWA, Mie (JP)

(21) Appl. No.: 17/281,243

(22) PCT Filed: Sep. 19, 2019
(86) PCT No.: PCT/JP2019/036673

§ 371 Date: Mar. 30, 2021

(30) Foreign Application Priority Data
Oct. 4, 2018 (JP) 2018-188869

(51) Int. Cl. H01B 7/295; C09D 171/02; C09D 123/12; H01B 3/44

(52) U.S. Cl. CPC H01B 7/295; H01B 3/441; C09D 123/12; C09D 171/02

(57) ABSTRACT

It is aimed to provide an insulated wire capable of enhancing the flame retardancy thereof by a method other than a method for increasing a content of a flame retardant in an insulation coating. An insulated wire includes a wire conductor and an insulation coating made of a resin composition for covering an outer periphery of the wire conductor. A cross-sectional area ratio S defined as a ratio S2/S1 of a cross-sectional area S2 of the insulation coating to a conductor cross-sectional area S1 and an oxygen index OI of the resin composition constituting the insulation coating satisfy a relationship of S≤OI−17.2.

### TECHNICAL FIELD

The present disclosure relates to an insulated wire.

### BACKGROUND

Insulated wires used in vehicles such as automotive vehicles and various devices are required to have high flame retardancy. For example, if a non-halogen resin such as a polyolefin resin is used as a material of an insulation coating constituting an insulated wire, flame retardancy is ensured by mixing a flame retardant made of a phosphorus-based compound. For example, Patent Document 1 describes that 30 parts by mass or more of a flame retardant is contained in 100 parts by mass of a polyolefin-based resin having a predetermined composition.

### PRIOR ART DOCUMENT

### Patent Document

Patent Document 1: JP 2017-066345 A

### SUMMARY OF THE INVENTION

### Problems to be Solved

As also described in Patent Document 1, the flame retardancy of the insulation coating can be enhanced by containing the flame retardant in the insulation coating constituting the insulated wire. However, mechanical properties and the like of the resin material constituting the insulation coating may be possibly affected by containing a large amount of the flame retardant. Thus, the content of the flame retardant is preferably suppressed to be small in a range in which necessary flame retardancy can be ensured. Accordingly, a means for enhancing the flame retardancy of the insulated wire is desired, besides increasing the content of the flame retardant.

Accordingly, it is aimed to provide an insulated wire capable of enhancing the flame retardancy thereof also by a method other than a method for increasing the content of a flame retardant in an insulation coating.

### Means to Solve the Problem

The present disclosure is directed to an insulated wire with a wire conductor and an insulation coating made of a resin composition for covering an outer periphery of the wire conductor, wherein a cross-sectional area ratio S defined as a ratio S2/S1 of a cross-sectional area S2 of the insulation coating to a conductor cross-sectional area S1 and an oxygen index OI of the resin composition constituting the insulation coating satisfy a relationship of S≤OI−17.2.

### Effect of the Invention

The insulated wire according to the present disclosure can enhance the flame retardancy thereof also by a method other than a method for increasing the content of a flame retardant in the insulation coating.

### BRIEF DESCRIPTION OF THE DRAWINGS

FIGS. 1A and 1B are views showing an insulated wire according to one embodiment of the present disclosure, wherein FIG. 1A is a perspective view and FIG. 1B is a circumferential section.

FIG. 2 is a graph showing a relationship of an oxygen index, a cross-sectional area ratio and flame retardancy for experimental data.

FIG. 3A is a graph showing a relationship of the oxygen index and the flame retardancy for experimental data and FIG. 3B is a graph showing a relationship of the oxygen index, an insulation thickness and the flame retardancy for experimental data.

### DETAILED DESCRIPTION TO EXECUTE THE INVENTION

### Description of Embodiments of Present Disclosure

First, embodiments of the present disclosure are listed and described.

An insulated wire of the present disclosure includes a wire conductor and an insulation coating made of a resin composition for covering an outer periphery of the wire conductor, wherein a cross-sectional area ratio S defined as a ratio S2/S1 of a cross-sectional area S2 of the insulation coating to a conductor cross-sectional area S1 and an oxygen index OI of the resin composition constituting the insulation coating satisfy a relationship of S≤OI−17.2.

In the above insulated wire, the cross-sectional area ratio S and the oxygen index OI of the insulation coating satisfy the relationship of S≤OI−17.2. By reducing the cross-sectional area of the insulation coating with respect to the conductor cross-sectional area, the heat of the insulation coating is more easily dissipated to the wire conductor and the temperature of the insulation coating is less likely to rise. As a result, the flame retardancy of the insulated wire is enhanced. Even when the oxygen index of the resin composition constituting the insulating coating is low due to the inclusion of only a small amount of the flame retardant, the insulating coating is formed thinly to reduce the cross-sectional area S2 of the insulating coating with respect to the conductor cross-sectional area S1. Therefore, if the cross-sectional area ratio S is lowered to satisfy the above relationship, high flame retardancy can be ensured in the insulated wire.

The formation of the thin insulation coating leads also to a diameter reduction of the insulated wire. If a large amount of the flame retardant is contained when the insulation coating is thinned, there is a possibility that mechanical properties of the insulation coating such as abrasion resistance are reduced. However, since the oxygen index may be low in the above insulated wire if the cross-sectional area ratio is sufficiently small, the content of the flame retardant can be suppressed to be small. Therefore, influences on mechanical properties of a resin component by the addition of the flame retardant can be suppressed to be small.

Here, the cross-sectional area ratio S may be 2.5 or less. Then, even if the oxygen index of an insulating material constituting the insulation coating is fairly low, high flame retardancy is easily obtained in the insulated wire. Further, by thinning the insulation coating, a diameter reduction of the insulated wire is more easily achieved.

Further, the cross-sectional area ratio S may be 1.5 or less. Then, an effect of enhancing the flame retardancy of the insulated wire and an effect of reducing a diameter of the insulated wire are particularly excellent.

The resin composition constituting the insulation coating may contain polypropylene and polyphenylene ether. Then, even if the insulation coating is formed to be thin to reduce the cross-sectional area ratio and improve the flame retardancy of the insulated wire, high abrasion resistance is easily ensured. Further, the chemical resistance and heat resistance of the insulation coating are also enhanced.

Further, the resin composition constituting the insulation coating may contain a flame retardant made of a phosphate ester compound, and a content of the flame retardant may be less than 30 parts by mass for 100 parts by mass of a resin component. Then, the oxygen index of the resin composition can be enhanced by containing the flame retardant. By suppressing the content of the flame retardant to 30 parts by mass or less, a reduction in the mechanical properties of the insulation coating such as abrasion resistance due to a large content of the flame retardant can be suppressed.

In this case, the cross-sectional area ratio S may be 2.5 or less and the content of the flame retardant in the resin composition may be 10 parts by mass or less for 100 parts by mass of the resin component. Then, the insulation coating can be effectively thinned while the flame retardancy and abrasion resistance of the insulated wire are combined.

Further, the cross-sectional area ratio S may be 1.5 or less and the content of the flame retardant in the resin composition may be 5 parts by mass or less for 100 parts by mass of the resin component. Then, the effect of thinning the insulation coating is particularly excellent while the flame retardancy and abrasion resistance of the insulated wire are combined.

The conductor cross-sectional area S1 may be 0.10 mm² or less. Then, by reducing a diameter of the conductor, the effect of reducing the diameter of the entire insulated wire is particularly excellent, together with the effect of thinning the insulation coating.

### Details of Embodiment of Present Disclosure

Hereinafter, an insulated wire according to one embodiment of the present disclosure is described in detail using the drawings. In this specification, various physical properties of materials indicate values measured at a room temperature in the atmosphere unless otherwise specified.

[1] Configuration of Insulated Wire

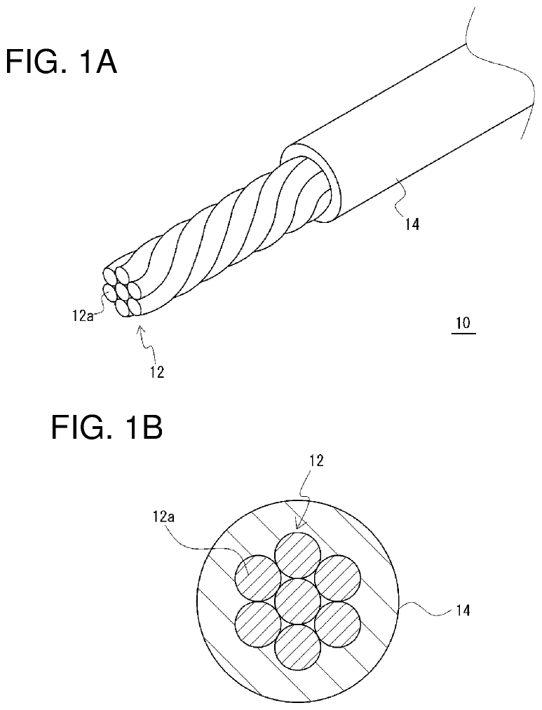

FIGS. 1A and 1B schematically show an insulated wire 10 according to one embodiment of the present disclosure. As shown in FIGS. 1A and 1B, the insulated wire 10 includes a wire conductor 12 and an insulation coating 14 made of a resin composition for covering the outer periphery of the wire conductor 12. The insulated wire 10 can be obtained by extruding the resin composition, which becomes the insulation coating 14, to the outer periphery of the wire conductor 12 to cover the outer periphery.

In the insulated wire 10 according to this embodiment, a cross-sectional area ratio S and an oxygen index OI of the resin composition constituting the insulation coating 14 satisfy the following Equation (1) with A set to 17.2.

S≤OI−A (1)

Here, the cross-sectional area ratio S of the insulated wire 10 is expressed as follows with a conductor cross-sectional area, i.e. a cross-sectional area of the wire conductor 12 in a cross-section (FIG. 1B) perpendicular to an axis of the insulated wire 10, denoted by S1 and an insulation cross-sectional area, i.e. a cross-sectional area of the insulation coating 14 in the same cross-section, denoted by S2.

S=S2/S1 (2)

The oxygen index OI is a minimum oxygen concentration (% by volume) necessary to sustain the combustion of a material and can be measured, for example, according to JIS K7201-2.

In the insulated wire 10 according to this embodiment, the cross-sectional area ratio S and the oxygen index OI satisfy Equation (1) with A set to 17.2, whereby the insulated wire 10 has flame retardancy sufficiently high for use in a vehicle such as an automotive vehicle. Even higher flame retardancy can be ensured if Equation (1) is satisfied with A set to be greater than 17.2. For example, A may be set to 17.5 or further to 18.0.

In the insulated wire 10, even if the insulation coating 14 is heated due to an external environment or by self-ignition, the heat of the insulation coating 14 can be dissipated to the wire conductor 12 and the heat of the insulation coating 14 can be absorbed by the wire conductor 12. By this phenomenon, a high temperature rise of the insulation coating 14 can be suppressed (heat dissipation). This heat dissipation has a higher effect as the volume of the wire conductor 12 increases with respect to the volume of the insulation coating 14. In other words, the heat dissipation effect is higher as the insulation coating 14 becomes thinner with respect to the wire conductor 12. That is, the heat dissipation effect can be enhanced as the cross-sectional area ratio S defined by Equation (2) decreases.

The insulation coating 14 is less likely to be combusted as the oxygen index OI of the resin composition constituting the insulated wire 10 increases. However, even if the oxygen index OI of the resin composition is low, the insulation coating 14 can be made less likely to be combusted by utilizing the heat dissipation by the wire conductor 12. Further, even if the insulation coating 14 is ignited, the insulation coating 14 can be quickly extinguished. In the insulated wire 10, the heat dissipation effect can be increased and the flame retardancy of the insulated wire 10 can be enhanced by forming the thin insulation coating 14 in a ratio to the conductor cross-sectional area S1 to reduce the cross-sectional area ratio S.

If the insulation coating 14 is thinned, an effect of reducing a diameter of the insulated wire 10 can also be obtained in addition to an effect of increasing the cross-sectional area ratio S and enhancing the flame retardancy of the insulated wire 10. In an automotive vehicle or the like, there is a large demand for a diameter reduction of the insulated wire 10 in terms of space saving.

If the cross-sectional area ratio S of the insulated wire 10 is suppressed to be equal to or less than an upper limit value determined in a relationship with the oxygen index OI of the resin composition as in Equation (1), sufficient flame retardancy can be ensured in the insulated wire 10 even if the insulation coating 14 is formed, utilizing a resin composition having a low oxygen index OI. The oxygen index OI of the resin composition depends on the types and formulations of a resin component and additive components other than the resin component, but the addition of a flame retardant is an example of a method for efficiently increasing the oxygen index OI. However, if a large amount of the flame retardant is added, mechanical properties of the resin component constituting the insulation coating 14 such as abrasion resistance are more easily affected.

If an addition amount of the flame retardant is suppressed to maintain the mechanical properties, the oxygen index OI of the resin composition constituting the insulation coating 14 is reduced. However, even in that case, sufficient flame retardancy can be ensured by thinning the insulation coating 14 to utilize the heat dissipation in the insulated wire 10. If the insulation coating 14 is thinned, the abrasion resistance of the insulation coating 14 tends to decrease, but a reduction of abrasion resistance due to the addition of the flame retardant is suppressed by suppressing the addition amount of the flame retardant to be small. That is, by thinning the insulation coating 14 and reducing the addition amount of the flame retardant within a range to satisfy the relationship of the cross-sectional area ratio S and the oxygen index OI specified by Equation (1), the insulated wire 10 can be reduced in diameter while both the flame retardancy and abrasion resistance of the insulated wire 10 are maintained.

The use of the insulated wire 10 according to this embodiment is not particularly limited and the insulated wire 10 can be used in various applications such as for vehicles such as automotive vehicles, devices, information communication, electric power, ships and aircrafts. Among those, the insulated wire 10 can be suitably utilized as an automotive wire. In the field of automotive wires, the insulated wire 10 is required to have high flame retardancy due to requests such as the avoidance of a fire. Further, a diameter reduction of the insulated wire 10 is also required in terms of space saving. Furthermore, the automotive wire easily contacts a vehicle body and other parts during assembling and easily rubs against the vehicle body and the other parts during use and, hence, is required to have excellent abrasion resistance. In the insulated wire 10 according to this embodiment, the insulated wire 10 can be reduced in diameter while flame retardancy and abrasion resistance are combined, and the above properties required for automotive wires can be satisfied.

The insulated wire 10 according to this embodiment may be singly used or may be used in the form of a wiring harness including a plurality of insulated wires. All the insulated wires constituting the wiring harness may be the insulated wires 10 according to this embodiment or some of them may be the insulated wires 10 according to this embodiment.

The constituent materials and specific dimensions of the wire conductor 12 and the insulation coating 14 constituting the insulated wire 10 according to this embodiment are not particularly limited as long as the relationship of the above Equation (1) is satisfied. Preferred configuration examples are listed below.

[2] Wire Conductor

Various metal materials generally used as a conductor constituting a wire can be used as the wire conductor 12. Copper, aluminum, iron, magnesium or alloys of those metals and other metals can be illustrated as such metal materials. Out of these metals, copper or copper alloy can be most suitably used. Among various metal materials, copper and copper alloy have high thermal conductivity and provide a particularly high effect in improving the flame retardancy of the insulated wire 10 by the heat dissipation.

The wire conductor 12 may be constituted by a single-core wire or may be constituted by a stranded wire formed by twisting a plurality of strands 12a. In terms of ensuring the flexibility and the like of the insulated wire 10, the wire conductor 12 is preferably made of a stranded wire. In this case, all the strands 12a may be made of the same material or the strands 12a made of a plurality of different materials may be used.

The conductor cross-sectional area S1 of the wire conductor 12 is not particularly limited as long as the ratio S of the conductor cross-sectional area S1 and the insulation cross-sectional area S2 and the oxygen index OI of the insulation coating 14 satisfy the relationship of Equation (1). However, the conductor cross-sectional area S1 is preferably small in terms of reducing the diameter of the insulated wire 10. If the conductor cross-sectional area S1 is 0.15 mm² or less, further 0.10 mm² or less or 0.05 mm² or less, the insulated wire 10 can be effectively reduced in diameter by the effect of the thin wire conductor 12 and by the effect of thinning the insulation coating 14 to satisfy Equation (1) as the wire conductor 12 is reduced in diameter. A lower limit of the conductor cross-sectional area S1 is not particularly designated, but is preferably 0.03 mm² or more, such as in terms of enhancing the effect of the heat dissipation.

[3] Insulation Coating

A thickness of the insulation coating 14 is also not particularly limited as long as the ratio S to the conductor cross-sectional area S1 and the oxygen index OI of the insulation coating 14 satisfy the relationship of Equation (1). However, the insulation coating 14 is preferably thin in terms of enhancing flame retardancy by making the cross-sectional area ratio S as small as possible and in terms of reducing the diameter of the insulated wire 10. If the thickness of the insulation coating 14 is 0.20 mm or less, further 0.15 mm or less or 0.10 mm or less, the flame retardancy and diameter reduction of the insulated wire 10 can be effectively improved. A lower limit of the thickness is not particularly designated, but is preferably 0.08 mm or more, such as in terms of easily ensuring the abrasion resistance of the insulation coating 14.

A specific value of the cross-sectional area ratio S is also not particularly limited. However, by setting the cross-sectional area ratio S to 4.0 or less, the effect of improving flame retardancy and the effect of reducing the diameter of the insulated wire 10 tend to be excellent. Further, if the cross-sectional area ratio S is set to 2.5 or less or 1.5 or less, the cross-sectional area ratio S easily satisfies the relationship of Equation (1) for the oxygen index OI of each of various resin compositions assumed as the material of the insulation coating 14 and high flame retardancy can be ensured in the insulated wire 10.

A component composition of the resin composition constituting the insulation coating 14 affects the flame retardancy of the insulated wire 10 through the oxygen index OI. However, the component composition of the resin composition can be arbitrarily selected, as long as it gives an oxygen index OI that satisfies Equation (1) with respect to the desired cross-sectional area ratio S.

Various polymer materials can be used as the resin component, which is a main component of the resin composition. Polyolefins such as polyethylene and polypropylene, engineering plastics such as polyvinyl chloride, polyphenylene ether and polyamide, thermoplastic elastomer, rubber and the like can be illustrated as such polymer materials. One type of the polymer material may be used or a plurality of types of the polymer materials may be mixed and used.

Among all listed above, mixtures of polyolefin and engineering plastic can be examples of a preferable resin component. Those mixtures easily give a relatively high oxygen index OI, among various polymer materials. Further, since polyolefins are excellent in chemical resistance and oil resistance and engineering plastics are excellent in abrasion resistance, the insulation coating 14 easily ensured with abrasion resistance and excellent in chemical resistance and oil resistance can be formed by mixing and using these materials even if the insulation coating 14 is formed to be thin to reduce the cross-sectional area ratio S.

Examples of polyolefins constituting the above mixtures include polypropylene (PP) and polyethylene (PE). Further, examples of engineering plastics include polyphenylene ether (PPE), polyamide (PA), polybutylene terephthalate (PBT) and polycarbonate (PC). Polyolefin and engineering plastic preferably constitute a polymer alloy. A mixing ratio of polyolefin and engineering plastic is preferably 30:70 to 70:30 in a mass ratio of polyolefin and engineering plastic in terms of sufficiently exhibiting properties of each material.

Out of the above mixtures, a mixture (PP/PPE) of polypropylene (PP) and polyphenylene ether (PPE), particularly a polymer alloy of those, can be illustrated as a particularly preferable example. PP/PPE is a relatively inexpensive material, but excellent in abrasion resistance, chemical resistance and oil resistance.

Another polymer material may be further added to the mixture of polyolefin and engineering plastic. Thermoplastic elastomers including SEBS can be examples of such a polymer material. By adding thermoplastic elastomer, the flexibility and mechanical properties of the insulation coating 14 can be enhanced. An addition amount of thermoplastic elastomer may be 5 parts by mass or more with an amount of the entire resin component constituting the resin composition set to 100 parts by mass in terms of sufficiently obtaining an effect of addition. On the other hand, the addition amount may be 20 parts by mass or less, such as in terms of ensuring sufficient abrasion resistance.

The resin composition constituting the insulation coating 14 can contain various additives in addition to the resin component. A flame retardant can be illustrated as the additive. The type of the flame retardant is not particularly limited and phosphorus-based flame retardants such as phosphate ester compounds, bromide-based flame retardants, nitrogen-based flame retardants and metal compound-based flame retardants and the like can be illustrated as such. Out of these flame retardants, a flame retardant made of a phosphate ester compound is preferably used in terms of enhancing compatibility with the resin component and suppressing a reduction in mechanical properties.

The oxygen index OI of the resin composition can be enhanced by adding the flame retardant. However, if the content of the flame retardant is increased as described above, the mechanical properties of the resin composition such as abrasion resistance tend to be impaired. Particularly, if a large amount of the flame retardant is contained when the insulation coating 14 is formed to be thin, it becomes difficult to ensure sufficient abrasion resistance. Accordingly, it is preferred to enhance the flame retardancy of the insulated wire 10 not by increasing the content of the flame retardant, but by thinning the insulation coating 14 and reducing the cross-sectional area ratio S. That is, it is better to reduce the content of the flame retardant.

For example, when the flame retardant made of a phosphate ester compound is used, the content thereof in the resin composition is preferably less than 30 parts by mass, and further 20 parts by mass or less for 100 parts by mass of the resin component. Particularly, if the cross-sectional area ratio S of the insulated wire 10 is 2.5 or less, the insulated wire 10 satisfying Equation (1) and having high flame retardancy is easily formed even if the content of the flame retardant made of the phosphate ester compound is 10 parts by mass or less. Further, if the cross-sectional area ratio S of the insulated wire 10 is 1.5 or less, the insulated wire 10 satisfying Equation (1) and having high flame retardancy is easily formed even if the content of the flame retardant made of the phosphate ester compound is 5 parts by mass or less.

A specific value of the oxygen index OI itself is not particularly limited. However, the oxygen index OI of the resin composition assumed to be used as the insulation coating 14 is generally 18 or more. Further, the oxygen index OI is better to be 21 or more. On the other hand, the oxygen index OI is better to be 23 or less in terms of avoiding a large content of the flame retardant.

The resin composition constituting the insulation coating 14 may contain various additives besides the flame retardant. A filler, an antioxidant, an aging retardant, a lubricant, a plasticizer, a pigment and the like can be examples of such additives. However, the content of the additives other than the flame retardant is also preferably small in terms of easily ensuring abrasion resistance when the insulation coating 14 is thinned. For example, the content of various additives including the flame retardant is preferably less than 30 parts by mass, further 20 parts by mass or less or 10 parts by mass for 100 parts by mass of the resin component.

The insulation coating 14 may be formed by stacking a plurality of layers made of different resin compositions. In that case, a total value of cross-sectional areas of the respective layers may be used as the insulation cross-sectional area S2 in applying Equation (1). Further, a value obtained by weight-averaging oxygen indices of materials constituting the respective layers according to cross-sectional areas may be used as the oxygen index OI.

### Examples

Examples of the present invention are described below. Note that the present invention is not limited by these examples. Here, flame retardancy and abrasion resistance were evaluated for insulated wires having variously different conductor cross-sectional areas and oxygen indices and thicknesses of insulation coatings.

[Test Method]

(1) Fabrication of Samples

First, copper alloy stranded wires were prepared as wire conductors. Here, three types of wire conductors having different cross-sectional areas were prepared. Specifically, three types of wire conductors having nominal conductor sizes of 0.05 mm² (strand diameter of 0.11 mm, the number of strands is 7), 0.13 mm² (strand diameter of 0.18 mm, the number of strands is 7) and 0.35 mm² (strand diameter of 0.26 mm, the number of strands is 7) were prepared.

Further, components shown in Tables 1 and 2 were kneaded at a predetermined content ratio at 280° C. to prepare resin compositions used in fabricating samples A1 to A13 and samples B1 to B5. The obtained resin compositions were extruded to the outer peripheries of the wire conductors to have thicknesses shown in Tables 1 and 2, thereby forming insulation coatings.

Materials used as the respective components of the resin compositions constituting the insulation coatings are as follows.
PPE: “Zylon S201A” produced by Asahi Kasei Corporation
PP: “Novatec EC9” produced by Japan Polypropylene Corporation
SEBS: “Tough-Tek H1043” produced by Asahi Kasei Corporation
   Flame retardant: phosphate ester-based flame retardant (aromatic fused phosphate ester), “PX-200” produced by Daihachi Chemical Industry Co., Ltd.
   Antioxidant: Hindered phenol-based antioxidant, “Irganox 1010” produced by BASF

(2) Evaluation of Oxygen Index

The resin compositions having component compositions shown in Tables 1 and 2 are formed into sheets, and an oxygen index was evaluated for each IV-type test piece according to JIS K7201-2.

(3) Evaluation of Flame Retardancy

The flame retardancy of the insulated wire was evaluated according to ISO 6722. Specifically, each wire was cut to 600 mm, fixed while being inclined at 45° to a horizontal surface, and the flame of a gas burner was brought into contact with the cut wire at a position of 500 mm from an upper end. A case where a combustion time until flame extinguishment was 70 sec or less was evaluated as “A” having high flame retardancy. On the other hand, a case where the combustion time until flame extinguishment was more than 70 sec and a case where the flame was not extinguished were evaluated as “B” having low flame retardancy.

(4) Evaluation of Abrasion Resistance

The abrasion resistance of the insulated wire was evaluated by a blade reciprocating method according to ISO 6722. At this time, a load to be applied to a blade was 4N if the nominal conductor size was 0.05 mm² or 0.13 mm² and was 7 N if the nominal conductor size was 0.35 mm². A case where the number of reciprocations of the blade until the conductor was exposed, was equal to or more than a predetermined standard was evaluated as “A” having high abrasion resistance and a case where this number falls short of the predetermined standard was evaluated as “B” having low abrasion resistance. The predetermined standard was 50 if the nominal conductor size was 0.05 mm², 100 if the nominal conductor size was 0.13 mm² and 150 if the nominal conductor size was 0.35 mm².

[Result]

Tables 1 and 2 show the evaluation results of flame retardancy and abrasion resistance together with the content (unit: parts by mass) and the oxygen index (OI) of each component in the resin composition constituting the insulation coating, the conductor cross-sectional area (S1), the insulation thickness for each of the samples A1 to A13 and the samples B1 to B5. The insulation cross-sectional areas (S2) and the cross-sectional area ratios (S) are also shown in Tables 1 and 2. The insulation cross-sectional area (S2) is calculated by subtracting the conductor cross-sectional area (S1) from an actual measurement value of the cross-sectional area of the insulated wire. The cross-sectional area ratio (S) is calculated by dividing the insulation cross-sectional area (S2) by the conductor cross-sectional area (S1).

TABLE 1

| Sample Number | | A1 | A2 | A3 | A4 | A5 | A6 | A7 |
|---|---|---|---|---|---|---|---|---|
| Content | PPE | 45 | 45 | 45 | 45 | 50 | 40 | 50 |
| (parts | PP | 45 | 45 | 45 | 45 | 40 | 50 | 40 |
| by mass) | SEBS | 10 | 10 | 10 | 10 | 10 | 10 | 10 |
| | Flame Retardant | 5 | 10 | 20 | 20 | 5 | 5 | 10 |
| | Antioxidant | 0.5 | 0.5 | 0.5 | 0.5 | 0.5 | 0.5 | 0.5 |

| | | | | | | | |
|---|---|---|---|---|---|---|---|
| Oxygen Index (OI) | 20.0 | 21.0 | 22.0 | 22.0 | 20.3 | 19.8 | 21.3 |
| Conductor Cross-Sectional | 0.1451 | 0.0491 | 0.0491 | 0.1451 | 0.1451 | 0.1451 | 0.0491 |
| Area S1 (mm²) | | | | | | | |
| Nominal Conductor Size | 0.13 | 0.05 | 0.05 | 0.13 | 0.13 | 0.13 | 0.05 |
| (mm²) | | | | | | | |
| Insulation Thickness | 0.10 | 0.10 | 0.15 | 0.20 | 0.10 | 0.10 | 0.10 |
| (mm) | | | | | | | |
| Insulation Cross-Sectional | 0.166 | 0.110 | 0.188 | 0.431 | 0.166 | 0.166 | 0.110 |
| Area S2 (mm²) | | | | | | | |
| Cross-Sectional Area Ratio | 1.1 | 2.2 | 3.8 | 3.0 | 1.1 | 1.1 | 2.2 |
| (S = S2/S1) | | | | | | | |
| Flame Retardancy | A (30 sec) | A (25 sec) | A (30 sec) | A (15 sec) | A (15 sec) | A (40 sec) | A (15 sec) |
| (Combustion Time) | | | | | | | |
| Abrasion Resistance | A (150) | A (70) | A (150) | A (750) | A (200) | A (120) | A (70) |
| (Number of Reciprocations) | | | | | | | |

| Sample Number | | A8 | A9 | A10 | A11 | A12 | A13 |
|---|---|---|---|---|---|---|---|
| Content | PPE | 40 | 60 | 45 | 45 | 45 | 45 |
| (parts | PP | 50 | 30 | 45 | 45 | 45 | 50 |
| by mass) | SEBS | 10 | 10 | 10 | 10 | 10 | 5 |
| | Flame Retardant | 20 | 10 | 20 | 30 | 30 | 5 |
| | Antioxidant | 0.5 | 0.5 | 0.5 | 0.5 | 0.5 | 0.5 |

| | | | | | | |
|---|---|---|---|---|---|---|
| Oxygen Index (OI) | 21.8 | 22.0 | 22.0 | 22.5 | 22.5 | 19.8 |
| Conductor Cross-Sectional | 0.0491 | 0.1451 | 0.3436 | 0.1451 | 0.0491 | 0.1451 |
| Area S1 (mm²) | | | | | | |
| Nominal Conductor Size | 0.05 | 0.13 | 0.35 | 0.13 | 0.05 | 0.13 |
| (mm²) | | | | | | |
| Insulation Thickness | 0.15 | 0.10 | 0.20 | 0.20 | 0.10 | 0.10 |
| (mm) | | | | | | |
| Insulation Cross-Sectional | 0.188 | 0.166 | 0.579 | 0.431 | 0.110 | 0.166 |
| Area S2 (mm²) | | | | | | |
| Cross-Sectional Area Ratio | 3.8 | 1.1 | 1.7 | 3.0 | 2.2 | 1.1 |
| (S = S2/S1) | | | | | | |
| Flame Retardancy | A (25 sec) | A (5 sec) | A (10 sec) | A (20 sec) | A (10 sec) | A (40 sec) |
| (Combustion Time) | | | | | | |
| Abrasion Resistance | A (120) | A (180) | A (1200) | A (500) | B (15) | A (170 |
| (Number of Reciprocations) | | | | | | |

TABLE 2

| Sample Number | | B1 | B2 | B3 | B4 | B5 |
|---|---|---|---|---|---|---|
| Content | PPE | 45 | 45 | 45 | 45 | 50 |
| (parts | PP | 45 | 45 | 45 | 45 | 40 |
| by mass) | SEBS | 10 | 10 | 10 | 10 | 10 |
| | Flame Retardant | 5 | 10 | 20 | 30 | 5 |
| | Antioxidant | 0.5 | 0.5 | 0.5 | 0.5 | 0.5 |

| | | | | | |
|---|---|---|---|---|---|
| Oxygen Index (OI) | 20.0 | 21.0 | 22.0 | 22.5 | 20.3 |
| Conductor Cross-Sectional | 0.1451 | 0.0491 | 0.0491 | 0.0491 | 0.1475 |
| Area S1 (mm²) | | | | | |
| Nominal Conductor Size | 0.13 | 0.05 | 0.05 | 0.05 | 0.13 |
| (mm²) | | | | | |
| Insulation Thickness | 0.20 | 0.20 | 0.20 | 0.20 | 0.23 |
| (mm) | | | | | |
| Insulation Cross-Sectional | 0.431 | 0.431 | 0.431 | 0.283 | 0.515 |
| Area S2 (mm²) | | | | | |
| Cross-Sectional Area Ratio | 3.0 | 8.8 | 8.8 | 5.8 | 3.5 |
| (S = S2/S1) | | | | | |
| Flame Retardancy | B (80 sec) | B (not extinguished) | B (not extinguished) | B (80 sec) | B (85 sec) |
| (Combustion Time) | | | | | |
| Abrasion Resistance | A (1300) | A (750) | A (300) | B (40) | A (2000) |
| (Number of Reciprocations) | | | | | |

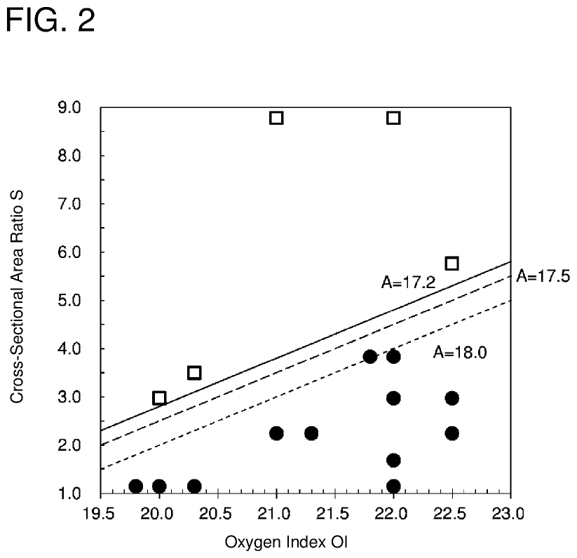

Further, FIG. 2 shows a relationship of the cross-sectional area ratio, the oxygen index and the evaluation result of flame retardancy. A vertical axis represents the cross-sectional area ratio, a horizontal axis represents the oxygen index, data points of the samples A1 to A13 having an evaluation result “A” are shown by circles (●) and data points of the samples B1 to B5 having an evaluation result “B” are shown by rectangles (□).

According to FIG. 2, it is understood that high flame retardancy is obtained in a region where the cross-sectional area ratio is small at each oxygen index. That is, the flame retardancy of the insulated wire can be improved by forming the thin insulation coating in a ratio to the conductor cross-sectional area.

However, the cross-sectional area ratios capable of achieving high flame retardancy evaluated as “A” differ according to the oxygen index. As the oxygen index increases, high flame retardancy is obtained even if the cross-sectional area ratio is large. As shown by a solid line in FIG. 2, cases where high flame retardancy evaluated as “A” was obtained and cases where high flame retardancy was not obtained, can be divided by a right-up straight line of OI=S+A with A set to 17.2, and high flame retardancy is obtained in a region below the straight line, i.e. in a region where the cross-sectional area ratio is small. As just described, the relationship of the cross-sectional area ratio and the flame retardancy can be evaluated using a linear function of the oxygen index, and the insulated wire having high flame retardancy can be obtained by adopting a cross-sectional area ratio equal to or smaller than a value specified by that linear function. In FIG. 2, straight lines with A=17.5 and A=18.0 are also shown by a broken line and a dotted line, respectively. A region having high flame retardancy can be more strictly selected, using those straight lines.

If the content of the flame retardant is reduced in the resin composition, the oxygen index tends to decrease. However, in that case, sufficient flame retardancy can be ensured by reducing the cross-sectional area ratio. For example, if the cross-sectional area ratio is set to 2.5 or less, high flame retardancy is obtained even if the content of the flame retardant is reduced to 10 parts by mass or less (samples A1, A2, A5 to A7, A9 and A13). Further, if the cross-sectional area ratio is set to 1.5 or less, high flame retardancy is obtained even if the content of the flame retardant is reduced to 5 parts by mass or less (samples A1, A5, A6 and A13).

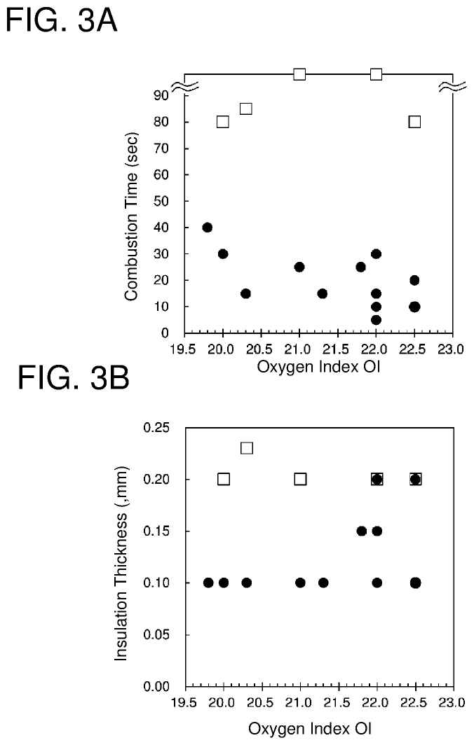

FIG. 3A shows a combustion time obtained in the flame retardancy evaluation test in relation to the oxygen index. According to this result, data points are distributed in regions having largely different combustion times even at the same oxygen index. The oxygen index is an index having a correlation with the flame retardancy of the resin composition. From FIG. 3A, it can be said that the flame retardancy of the insulated wire cannot be sufficiently evaluated only by the oxygen index of the resin composition constituting the insulation coating.

FIG. 3B shows a relationship of the insulation thickness, the oxygen index and the evaluation result of flame retardancy. FIG. 3B is equivalent to a graph obtained by replacing the cross-sectional area ratio on the vertical axis of FIG. 2 by the insulation thickness. Unlike in FIG. 2, data points (●) evaluated to have high flame retardancy and data points (□) evaluated to have low flame retardancy are not distributed in regions clearly divided on the graph in FIG. 3B. For example, data points (●) having high flame retardancy and data points (□) having low frame retardancy overlap at two positions where the insulation thickness is 0.20 mm From this, it can be said that not the thickness of the insulation coating and the value of the cross-sectional area, but a ratio to the conductor cross-sectional area needs to be used as an index for evaluating the flame retardancy of the insulated wire, together with the oxygen index of the resin composition.

Finally, the abrasion resistance evaluation results are compared for the respective samples in Tables 1 and 2. Abrasion resistance is low in the samples A12 and B4 in which the content of the flame retardant is 30 parts by mass. Also in the sample A11, the number of reciprocations in the evaluation is relatively small. In terms of obtaining sufficiently high abrasion resistance, the content of the flame retardant is preferably suppressed to be less than 30 parts by mass. Further, although the content of SEBS differs in the samples A6 and A13, similar flame retardancy is obtained by having the same oxygen index, but abrasion resistance is higher in the sample A13 having a smaller content of SEBS.

Although the embodiment of the present invention has been described in detail above, the present invention is not limited to the above embodiment at all and various changes can be made without departing from the gist of the present invention.

### LIST OF REFERENCE NUMERALS

10 insulated wire
12 wire conductor
12a strand
14 insulation coating

1. An insulated wire, comprising:
a wire conductor; and
an insulation coating made of a resin composition for covering an outer periphery of the wire conductor,
wherein:
a cross-sectional area ratio S defined as a ratio S2/S1 of a cross-sectional area S2 of the insulation coating to a conductor cross-sectional area S1 and an oxygen index OI of the resin composition constituting the insulation coating satisfy a relationship of S≤OI−17.2,
the cross-sectional area ratio S is 1.5 or less, and
the resin composition constituting the insulation coating contains a flame retardant made of a phosphate ester compound, and a content of the flame retardant in the resin composition is 5 parts by mass or less for 100 parts by mass of a resin component.

2. The insulated wire according to claim 1, wherein the resin composition constituting the insulation coating contains polypropylene and polyphenylene ether.

3. The insulated wire according to claim 1, wherein the conductor cross-sectional area S1 is 0.10 mm² or less.

4-8. (canceled)
